(19) United States
(12) Patent Application Publication
(10) Pub. No.: US 2006/0015821 A1
(43) Pub. Date: Jan. 19, 2006

(54) Document display system

(76) Inventors: Peter Joseph Jacques Parker, Dorking (GB); John Michael Chester Day, Colchester (GB); Andrew John Gooden, Halstead (GB)

Correspondence Address: DIEDERIKS & WHITELAW, PLC, 12471 Dillingham Square, #301, Woodbridge, VA, 22192, US

(21) Appl. No.: 11/181,909

(22) Filed: Jul. 15, 2005

(30) Foreign Application Priority Data
Jul. 16, 2004 (GB) 0416038.8

(51) Int. Cl. G06F 3/00

(52) U.S. Cl. 715/800

(57) ABSTRACT

A scientific article is displayed as three frames, a title frame, a text frame, and a figures and tables frame, in a browser window. The title frame displays bibliographic information for the article in question. The text frame is used to display the text of each section of the article. The figures frame is used to display the figures, tables and any other non-text items of the article. Links are provided in the text frame that, when clicked, will display the appropriate figure or table in the figures and tables frame.

### BACKGROUND OF THE INVENTION

1. Field of the Invention

The present invention relates to a system for the electronic display of documents, such as scientific articles and journals, and in particular to such display in an “online” manner, e.g. on the Internet or other computer networks.

2. Discussion of the Prior Art

Scientific papers and journals have traditionally been published in a paper (hard copy) format. However, with the advent of the Internet, it has become increasingly common to publish scientific journals “online” in an electronic format.

Initially, “online” publication of scientific articles consisted of portable document format (pdf) versions of the physical pages. Subsequently, articles were published in hypertext markup language (HTML) format. These HTML representations of articles still tended to have a flat, linear layout, with the entire article constituting one HTML “page”, but had the advantage that hypertext links could be used to allow a user to navigate more easily through the article. However, there still remained drawbacks, such as the fact that, e.g., figures and tables would be embedded in the body of the article, such that it could be difficult to view them simultaneously with the desired text.

Various proposals have therefore been made to improve the electronic presentation of scientific articles and journals, for example to try to alleviate the drawbacks of the linear aspect of the basic HTML page-type presentation.

Such proposals have included breaking articles into separate sections so as to allow easier “browsing” of the article, and, for example, removing non-textual information such as figures, tables, etc., from the body of the article and making that information available as separate pages that can be viewed in separate browser windows.

While these proposals do provide some improvement in the “readability” of an online scientific article (paper), the Applicants believe that there remains scope for further improvements in the presentation of scientific articles and journals in an electronic format.

### SUMMARY OF INVENTION

According to a first aspect of the present invention, there is provided a method of displaying electronically a scientific article, comprising:
displaying the article using three or more separate frames in a single window on an electronic display, each frame displaying different information relating to the article.

According to a second aspect of the present invention, there is provided a system for the electronic display of scientific articles, comprising:
means for displaying an article using three or more frames simultaneously in a single window on an electronic display; and
means for displaying in each frame different information relating to the article.

In the present invention, a scientific article is displayed using three (or more) frames in a single window. This allows, for example, information such as text and figures from different parts of the “paper” article to be displayed simultaneously on the screen and without the need, e.g., for a user to have to switch between windows to view that information.

As discussed above, the present invention is particularly applicable to the online display of scientific articles and papers over the Internet. In that case, the window of the display will be a browser window of an Internet browser, and the frames will be appropriate frames (e.g. (and preferably) HTML frames) of and within the browser window. However, the invention is equally applicable to other display formats and arrangements that similarly can display separate navigable frames within a single overall window.

The number of frames that are used can be selected as desired, although in a particularly preferred embodiment, three frames (and only three frames) are used, as that has been found to provide a suitable compromise between the different types of information that it might be desirable to display simultaneously and the size and layout of the frames on a display screen.

The information that is displayed in each frame can equally be selected as desired.

However, particularly in the context of the display of scientific articles, it is particularly preferred for the three frames to comprise a “title” frame, a “text” frame and a “figures” frame. In such an arrangement, the “title” frame preferably displays bibliographic information for the article, the “text” frame displays the text of the article, and the “figures” frame preferably displays the figures, tables and any other non-text items of the article.

The layout of the frames in the display window can also be selected as desired. In a particularly preferred embodiment where three frames as discussed above are to be used, the title frame is preferably arranged across the full width of the top of the window, with the text and figure frames arranged side-by-side underneath the title frame. The text and figure frames are preferably set initially at least to be equal in size.

The provision of frames in this manner allows, e.g., the corresponding text and figures easily to be viewed at the same time, whilst also allowing bibliographic information of the article to be visible always, no matter what section of the text or figures is otherwise being viewed.

In a particularly preferred embodiment, a user can change the size of the frames that are displayed. Most preferably at least the figures frame can be resized by a user (with, where necessary, the text and/or title frames automatically resizing accordingly to retain the frames within the display window).

Where the size of the figures frame is varied, any figures, tables, etc., being displayed in that frame are preferably automatically resized as the frame size changes. Most preferably this is done so as to enable the whole figure, table, etc., to remain visible as the frame size changes. This is preferably achieved by the system comparing the size of the frame and the size of the image and resizing the image where necessary.

It is believed that such an arrangement may be new and advantageous in its own right. Thus, according to a third aspect of the present invention, there is provided a method of displaying a scientific article in an electronic form, comprising:
displaying figures of the article in a frame in a window on an electronic display; and
resizing automatically a figure being displayed when the size of the frame that the figure is displayed in is changed.

According to a fourth aspect of the present invention, there is provided an apparatus for displaying a scientific article in an electronic form, comprising:
means for displaying figures of the article in a frame in a window on an electronic display; and
means for resizing automatically a figure being displayed when the size of the frame that the figure is displayed in is changed.

In a particularly preferred embodiment the system determines the size of the figures frame relative to the display window, and where it determines that that frame is equal to or greater than a particular proportion of the display window (preferably more than 50% of the display window), automatically displays a higher resolution image of the figure in the frame. This has the advantage of automatically providing a more detailed version of a figure where the frame size permits.

It is again believed that such an arrangement may be new and advantageous in its own right. Thus, according to a fifth aspect of the present invention, there is provided a method of displaying electronically a scientific article, comprising:
displaying figures of the article in a frame within a display window; and
automatically displaying a higher resolution image of a figure when the frame for displaying the figure equals or exceeds a selected proportion of the window size.

According to a sixth aspect of the present invention, there is provided an apparatus for displaying electronically a scientific article, comprising:
means for displaying figures of the article in a frame within a display window; and
means for automatically displaying a higher resolution image of a figure when the frame for displaying the figure equals or exceeds a selected proportion of the window size.

In a particularly preferred embodiment, one or more than one of the frames, and preferably at least the text and figure frames, are arranged so as to facilitate navigation by a user through the information to be displayed in those frames. To facilitate this, the information to be displayed in a frame is preferably divided into discrete, identifiable sections that a user can then navigate between. For example, the text could be divided into different sections and each figure or table treated as a different section of information.

Thus, in a particularly preferred embodiment, a frame or more than one frame, and most preferably each frame, of the display, contains navigation features to facilitate navigation through the information to be displayed in the frame in question.

The appropriate frame or frames thus preferably accordingly also provide user-operable controls to facilitate navigation through the information to be displayed. These controls are preferably provided in the form of a drop-down menu or menus to facilitate navigation through the information to be displayed in the frame. Thus, for example, both the text and figures frames preferably include drop-down menus to allow a user to navigate between, e.g., different sections of text, different figures and tables, etc., as appropriate. Preferably a facility to view, e.g., all the figures and tables in one page is also provided. Using dropdown menus in this way facilitates making each part of an article more easily accessible, whilst still making efficient use of display space.

In a particularly preferred embodiment, a user can browse an article section-by-section and/or figure-by-figure. This is preferably achieved by providing appropriate browse buttons in one or more of the frames, and most preferably at least in the text and figures frames. Most preferably a set of “first”, “previous”, “next” and “last” browse buttons are provided.

In a preferred embodiment, a user can also change or select the information displayed in one frame by activating a function in a different frame. Thus, for example, a user can preferably select a figure or table to be displayed in the figures frame from the text frame (and vice-versa). This allows a user more easily to view the appropriate text and figures (or tables, etc.) simultaneously. Such functionality is preferably provided by means of links (e.g. hypertext links) in the information displayed that can be activated when desired by a user.

It is similarly preferred to allow a user to be able to access additional information from within a frame when a user so desires. Again, such functionality is preferably provided in the form of links within the information displayed that can be activated by a user to access additional or different information that could be of interest to them.

Thus, in a particularly preferred embodiment, the information displayed in a frame and preferably each frame can and does include links to allow a user, e.g., to change the information displayed and/or to access additional information. This could be, e.g., to display different or additional information in the current frame, or to change the information displayed in one of the other frames.

Thus, for example, in the title frame links are preferably provided to other versions of the article, and in the text frame, links are preferably provided to allow the appropriate figures, tables, etc., to be called up to be displayed in the figures frame. It is also preferred to, e.g., provide links to reference (citation) information (e.g. in the text and figures frames) where references are included in the text.

In a particularly preferred embodiment, additional information can be displayed in a frame or frames by means of a “pop-up” box that displays that information. Preferably the pop-up box or boxes are displayed by a user activating a link to the box in the frame (e.g. in the text displayed in the frame). Most preferably the pop-up box is activated by a user moving the cursor over the link. The use of pop-up boxes to display information in this manner has the advantage that, e.g., the main body of the text being displayed does not need to be changed when the pop-up box is activated, and so a user can, e.g., more easily return to their previous position in the article.

These pop-up boxes can be used to display any desired information. They are preferably used for displaying, e.g., author affiliation information in the title frame, and citation and reference information in the text or figures of the article.

As well as displaying the relevant information, the pop-up boxes can and preferably do include links to other information, such as links to an author's email address and other papers by the author (in the case of an “author affiliation” pop-up box) or links to abstracts for references (in the case of a reference or citation pop-up box).

The pop-up boxes can be displayed as desired. In a particularly preferred embodiment, the size of the pop-up box is set depending on the size of the frame from which it is called. Most preferably, the pop-up box is sized so as not to extend over the edge of the frame and/or window. Preferably the system detects the position of the cursor and the size of the frame and sets the size and position of the pop-up box accordingly. (Any suitable code can be used for performing these functions, such as suitable such code that is available on the Internet.)

The pop-up boxes preferably stay visible for as long as the cursor is either over the link or the pop-up box itself.

In a preferred embodiment, the system provides the facility to disable (turn on and off) the display of the pop-up boxes. This is preferably provided as a user-operable function in the title frame.

It is believed that the display of references and citation information in a pop-up box from a link in the body of the text or figures of an electronically displayed scientific article is new and advantageous in its own right, since, for example, it avoids the need to switch the display to the references section of an article to see the bibliographic information for a reference. Thus, according to a seventh aspect of the present invention, there is provided a method of displaying electronically a scientific article, comprising:
providing a link or links within the text of the article to bibliographic information for references included in the article; and
displaying the bibliographic information in a pop-up box when the link to such information is activated.

According to an eighth aspect of the present invention, there is provided an apparatus for displaying electronically a scientific article, comprising:
means for providing a link or links within the text of the article to bibliographic information for references included in the article; and
means for displaying the bibliographic information in a pop-up box when the link to such information is activated.

It is also believed that the display of author affiliation information in a pop-up box from a link in the body of the text or figures of an electronically displayed scientific article is new and advantageous in its own right. Thus, according to a ninth aspect of the present invention, there is provided a method of displaying electronically a scientific article, comprising:
providing a link or links within the text of the article to author affiliation information for an author or authors of or referred to in the article; and
displaying the author affiliation information in a pop-up box when the link to such information is activated.

According to a tenth aspect of the present invention, there is provided an apparatus for displaying electronically a scientific article, comprising:
means for providing a link or links within the text of the article to author affiliation information for an author or authors of or referred to in the article; and
means for displaying the author affiliation information in a pop-up box when the link to such information is activated.

As will be appreciated from the above, an article (or series of articles in the case of a scientific journal) for display in accordance with the present invention will need to be provided in the appropriate format for such display. This can be achieved in any suitable manner, and will depend, for example, on the display platform, etc., that is to be used.

In a particularly preferred embodiment, articles for display are provided as a set of appropriate components or files, containing, e.g., the information to be displayed and/or code necessary to carry out the various display functions. Most preferably a separate file is provided for each section of text, each figure and each table, together with an appropriate additional file or files containing code for the various display functions.

It is believed that such arrangements may be new and advantageous in their own right. Thus, according to an eleventh aspect of the present invention, there is provided a scientific article in electronic format for display, comprising:
a plurality of files, each file for displaying one section of text, or a figure, or a table of the article; and
one or more code files for providing display functions, which code files can be called via the files for displaying the text, figures or tables.

In a particularly preferred arrangement of these embodiments and aspects of the invention, each section of the text of the article, and each figure or table, is prepared as a separate HTML page (files). Each such page preferably also includes any necessary display components, such as drop-down menu and browse button functionality, pop-up box functionality and links, e.g., to figures, reference information, etc. Preferably, the HTML files include calls to appropriate files that provide the relevant functions, such as JavaScript files for pop-up boxes, drop-down menus, etc., so that the necessary code does not have to be repeated in every text or figures, etc., file. The relevant files containing this code will then be provided as additional files associated with the article.

As discussed above, there is preferably also provided a file (e.g. an HTML page) for displaying all the figures, and, preferably, a file (e.g. an HTML page) for displaying all the tables, in the articles. Preferably a separate file (e.g. HTML page) containing and for displaying the necessary reference (citation) information is also provided.

The layout of the display (such as the use of three frames, and their arrangement, etc.) is preferably set by a further file (e.g. HTML file) that defines the frameset to be used for the display.

These various files (HTML pages) can be prepared in any suitable manner.

Most preferably the data for the article is first extracted, and appropriately stored and referenced, and then the various pages for displaying the article generated. Preferably a file defining the frameset (frame layout) is generated first and then files for each text section, figure and table (preferably in that order) are generated. The generation of the figures and tables files preferably also includes generating an “all figures” file and an “all tables” file, as discussed above. Finally, a separate references file is also preferably generated, as discussed above.

It is again believed that such an arrangement may be new and advantageous in its own right. Thus, according to a twelfth aspect of the present invention, there is provided a method of formatting a scientific article for display in an electronic form, comprising:
storing data describing the article;
generating a file for defining the frameset to be used to display the article; and
generating files for displaying each text section, figure and table to be displayed for the article from the stored information.

According to a thirteenth aspect of the present invention, there is provided an apparatus for formatting a scientific article for display in an electronic form, comprising:
means for storing data describing the article;
means for generating a file for defining the frameset to be used to display the article; and
means for generating files for displaying each text section, figure and table to be displayed for the article from the stored information.

In the case of display of an article, as discussed above, as HTML frames within an Internet browser window, the articles for such display are preferably formatted as a combination of static HTML pages, ColdFusion templates and JavaScript scripts. Formatting of the articles in this way is preferably carried out by first describing the article in an XML form and then parsing the XML file to extract the information needed to generate the HTML tagging, JavaScript and ColdFusion code necessary to display the article.

It is again believed that such an arrangement may be new and advantageous in its own right. Thus, according to a fourteenth aspect of the present invention, there is provided a method of formatting a scientific article for display in an electronic form, comprising:
parsing an XML file describing the article to extract information needed to generate HTML tags, and JavaScript and ColdFusion code for describing the article; and
formatting the article as a combination of static HTML pages, ColdFusion templates, and JavaScript scripts, using the information extracted from the XML file.

According to a fifteenth aspect of the present invention, there is provided an apparatus for formatting a scientific article for display in an electronic form, comprising:
means for parsing an XML file describing the article to extract information needed to generate HTML tags, and JavaScript and ColdFusion code for describing the article; and
formatting the article as a combination of static HTML pages, ColdFusion templates, and JavaScript scripts, using the information extracted from the XML file.

The present invention also extends to an article in an electronic format that is provided in the manner of the present invention, or that has been generated in accordance with the present invention.

The present invention is, as will be appreciated from the above, particularly (although not exclusively) applicable to the online display of scientific articles and journals over the Internet. In such an arrangement, a server or servers will provide the articles in the appropriate format for access by users of client terminals.

In a particularly preferred such arrangement, the system is arranged such that search engines will not index individual components, e.g., pages, of an article to be viewed, and such that browsers will not cache individual components of an article to be viewed. This helps to avoid the problem of users potentially being directed to individual pages of an article without having the necessary display frames defined first. This can be done in any suitable manner, such as by including appropriate tags in the headers of the HTML files (where an HTML-based system is being used).

Although the present invention has been described above with particular reference to the display of scientific articles and journals, as will be appreciated by those skilled in the art, the principles of the present invention can also be applied to the electronic display of other documents, particularly documents that in similar manner to scientific articles, may contain both text and non-text information.

Thus, according to another aspect of the present invention, there is provided a method of displaying a document electronically, comprising:
displaying the document using three or more separate frames in a single window on an electronic display, each frame displaying different information relating to the document.

According to a further aspect of the present invention, there is provided a system for the electronic display of documents, comprising:
means for displaying a document using three or more frames simultaneously in a single window on an electronic display; and
means for displaying in each frame different information relating to the document.

The other aspects of the invention described herein can also similarly be applied to the display in general of documents in an electronic format.

As will be appreciated by those skilled in the art, all of the above aspects and embodiments of the invention can and preferably do include, as appropriate, any one or more or all of the preferred and optional features of the invention described herein.

The methods in accordance with the present invention may be implemented at least partially using software e.g. computer programs. It will thus be seen that when viewed from further aspects the present invention provides computer software specifically adapted to carry out the methods hereinabove described when installed on data processing means, and a computer program element comprising computer software code portions for performing the methods hereinabove described when the program element is run on data processing means. The invention also extends to a computer software carrier comprising such software which when used to operate a document display system comprising data processing means causes in conjunction with said data processing means said system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out hereinabove.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

### BRIEF DESCRIPTION OF THE DRAWINGS

A number of preferred embodiments of the present invention will now be described by way of example only and with reference to the accompanying drawings, in which:

FIG. 1 shows schematically the display of a scientific article in accordance with an embodiment of the present invention;

FIGS. 2, 3, 4 and 5 show schematically features of the display of a scientific article in accordance with an embodiment of the present invention; and

FIGS. 6, 7, 8, 9 and 10 are flow charts showing schematically one embodiment of a method of preparing articles for display in accordance with the present invention.

### DETAILED DESCRIPTION OF THE INVENTION

A preferred embodiment of the present invention will now be described. This embodiment will be described in the context of the use of an Internet browser for viewing a scientific article that can be displayed in accordance with the present invention. However, as will be appreciated by those skilled in the art, the present invention is not limited to such application, nor, for example, to the use of the particular software packages and applications that are described in the present embodiment.

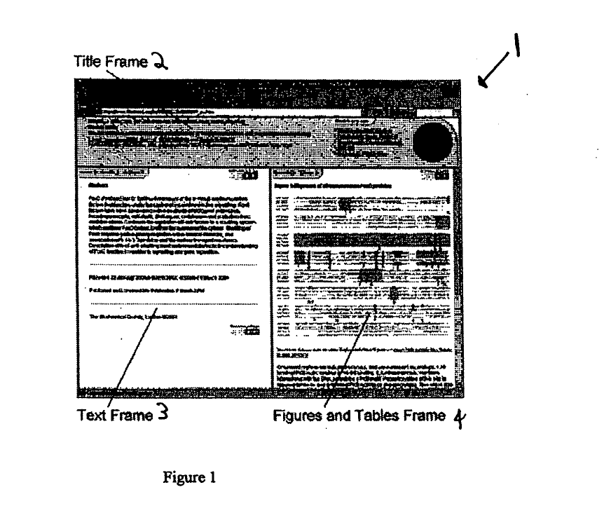

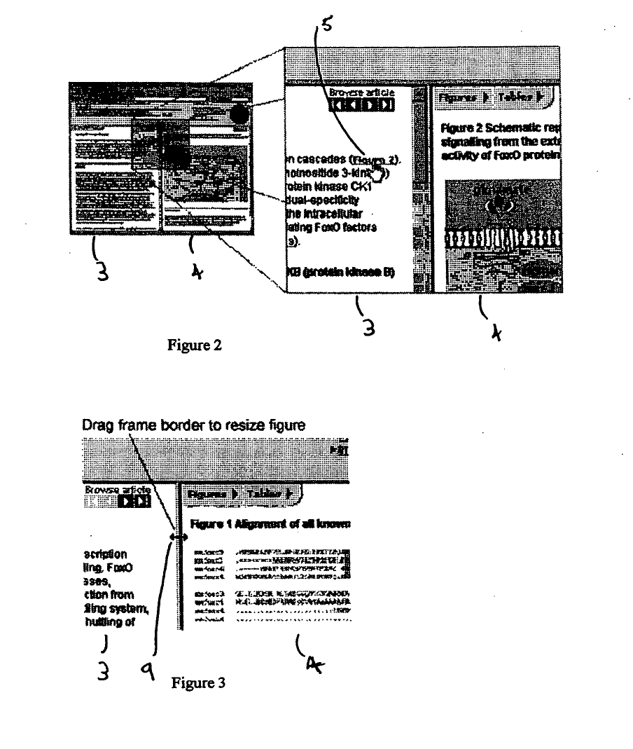

FIG. 1 shows schematically the display of a scientific article in accordance with the present embodiment. As shown in FIG. 1, the browser window 1 in which the article is viewed is arranged to comprise three frames, a title frame 2, a text frame 3, and a figures and tables frame 4.

The title frame 2 displays bibliographic information for the article in question, such as, for example, the abbreviated journal title, volume and page numbers, article title, authors, received, revised, accepted and published dates, and a Digital Object Identifier, and includes links to other versions of the article and a button to disable pop-ups. Links are also provided when an author's name is displayed so that when a user moves the cursor over the author's name, a pop-up box appears showing the author's affiliation. If the author is the corresponding author, a “mail to” link to their email address is also provided in the pop-up box.

The text frame 3 is used to display the text of each section of the article. There is a drop-down menu at the top of this frame to enable a user to navigate to any part of the text of the article, and there is also a set of first, next, previous and last buttons for browsing the article section-by-section. (The drop-down menu and browsing buttons can be generated using any suitable software.)

If a figure or table is referred to in the text, then a link 5 is also provided that, when clicked, will display the appropriate figure or table in the figures and tables frame 4. This is shown schematically in FIG. 2.

Where a citation in the text appears, a link is provided to the relevant reference information (e.g. in the references' section of the article). However, the references are arranged to appear as a pop-up box when the user moves the cursor over the reference link. In the present embodiment, this pop-up box shows the bibliographic information for the article being cited and includes a link or links to the abstract of the article, where available.

The figures frame 4 is used to display the figures, tables and any other non-text items of the article. There is a drop-down menu at the top of this frame that enables the user to navigate to any figure or table directly, and there is also a set of first, next, previous and last buttons for browsing the figures and tables one-by-one. The drop-down menu also provides an option to display all of the figures or tables in one page.

Any citations in the figure legends are provided with a link to provide a pop-up box containing the relevant citation information as described above in relation to the text frame 3.

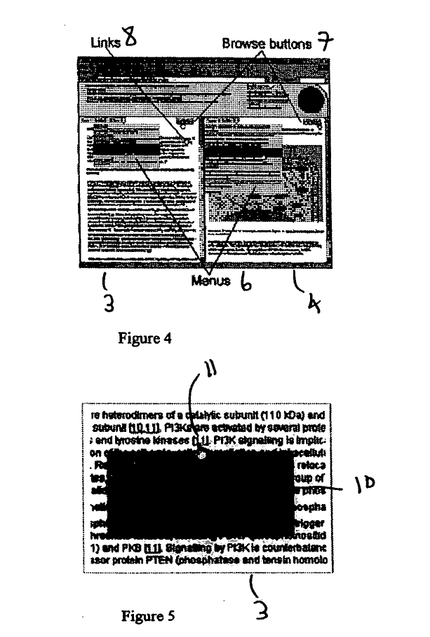

FIG. 4 shows schematically the provision of the drop-down menus 6, browse buttons 7 and links 8 in the text frame 3 and figures and tables frame 4.

FIG. 1 shows the initial, default layout of the frames 2, 3, 4 when an article is first displayed. In this initial arrangement, the title frame 2 is situated at the top of the browser window 1 and across the full width of the browser window, with the text frame 3 and figure and tables frame 4 side-by-side underneath the title frame 2 and equal in size. The initial display layout also loads default, initial information for display in the frames 2, 3, 4. In the present embodiment this comprises the standard title information in the title frame 2, the abstract in the text frame 3 and FIG. 1 in the figures and tables frame 4. Other text and figures to be displayed initially could be selected if desired.

In the present embodiment, a user can resize the frames displayed to suit their requirements, by dragging the frame border 9 to resize the frames. This is shown schematically in FIG. 3.

When the size of the figures and tables frame 4 is changed in this manner, the size of the figure (or table) that is currently displayed is automatically changed to match the resized figures and tables frame, so as to ensure that the whole figure (or table) will always be visible. This is achieved by placing the figure into a DHTML layer that is defined using a combination of the HTML <DIV></DIV> element and a CSS style sheet selector. The content of the layer is generated by a JavaScript function that is called by the JavaScript on Resize event handler placed in the <BODY> element of the page being displayed in the figures and tables frame 4. This function checks the size of the frame against the size of the image and if the frame is smaller works out what factor the image needs to be reduced by so that the whole figure will be visible and then adds the appropriate height and width attributes to the <IMG> tag.

Furthermore, if the system detects that the resized frame is more than 50% of the size of the browser window, a higher resolution version of the current figure is automatically loaded into the page to thereby allow the reader to see more detail than would otherwise be visible. (Because dynamic HTML is used, the page does not need to be reloaded to display these changes correctly.)

As discussed above, in the display system of the present embodiment, references in the text frame 3 or figures and tables frame 4 and author affiliations in the title frame 2 appear as pop-up boxes when the user moves the cursor over the appropriate link in the frame (i.e. over a citation link in the text frame 3 or figures and tables frame 4, or an author link in the title frame 2). These pop-up boxes are arranged to remain visible so long as the cursor is either over the link or the box itself. FIG. 5 shows schematically an example of such a pop-up box 10 activated by a link 11.

The use of such pop-up boxes is advantageous because it allows information that may be of less interest to a user to remain hidden, allows useful features such as links to an author's email address and redline searches for other papers by the author to be included in the pop-up box, and, e.g., avoids the need for a reader to click to the references section of an article to see the full bibliographic information for a reference.

As discussed above, a button is provided in the title frame 2 to disable pop-up boxes, should a user wish to do so.

In the present embodiment, the pop-up boxes are created as DHTML (Dynamic Hypertext Markup Language) layers using a combination of the HTML <DIV></DIV> element and a CSS style sheet selector. The pop-up box is generated by a JavaScript function that is called by the on Mouseover event. The text to be displayed in the pop-up box is passed to this function by using a pointer to an array element for references (as will be discussed further below, an array containing each reference on a page is created when the page is loaded) or is a string literal for an author's affiliation.

The JavaScript function that generates a pop-up box also detects the position of the mouse cursor and the size of the frame and sets the size and position of the pop-up box accordingly so as to avoid the possibility of the pop-up box disappearing over the edge of the browser window.

When the cursor is moved away from the link or the pop-up box, a function is called to set the visibility of the layer to false, thereby hiding the pop-up box.

Any suitable available code to generate pop-up boxes having these functions can be used, subject to any necessary modifications to achieve the functionality discussed above and/or to achieve interoperability with different platforms and browsers. For example, in the case of Mackintosh computers, it may be necessary to remove the <table></table> element in which the content is placed to enable the pop-up box to be displayed correctly.

The above describes the way that scientific articles and journals, etc., are displayed in the manner of the present invention. A suitable method for preparing and formatting articles for display in accordance with the present invention will now be described.

In this embodiment, the articles for display are prepared as a combination of static HTML pages, ColdFusion templates and JavaScript scripts. Such a format is suitable for display on an Internet browser using HTML frames, although, as will be appreciated by those skilled in the art, other formats could be used and may indeed be necessary where different display platforms are being used.

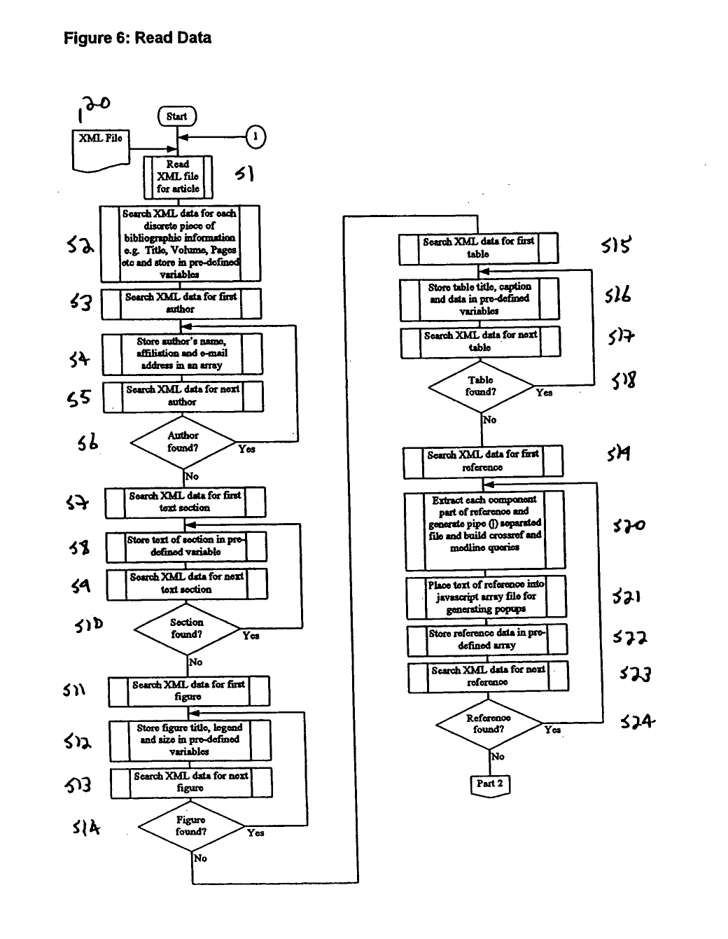

The files that are used to make up an article for display in the manner of the present invention in accordance with the present embodiment will now be described. A method for generating these files will then be described with reference to FIGS. 6 to 9.

In the following description, the following file naming convention is used:
vvv=a 3 digit volume number (with leading zeros);
pppp=a 4 digit first page number (with leading zeros); and
nn=a 2 digit figure, table or section number (again with leading zeros).

The first file that is used for each article is a so-called “frames” file that defines the frameset that makes up the display. Thus in the present embodiment, it defines the title frame 2, text frame 3, and figures and tables frame 4 that are used to display the article.

This frames file has, in the present embodiment, a file name of the format bjvvvpppp_ev.htm. It sets the default size for each frame and the first HTML page to display in each frame (in the present embodiment, the abstract in the text frame 3, and the first figure in the figures and table frame 4). It also contains the text that displays in the title bar of the browser window (in the HTML <TITLE></TITLE> tag).

Each formatted article then includes a file, bjvvvpppp_evtitle.htm, that contains the HTML code that displays the bibliographic information in the title frame and links to other versions of the article including the PDF file and Medline citation. This file also includes a JavaScript function (see below) that displays a pop-up box showing the author's address. As discussed below, the JavaScript function is included using a ColdFusion <CFINCLUDE> statement to avoid repetition of the same code in every file. The function is triggered by the JavaScript on MouseOver event when a user moves their mouse cursor over the author's name link. The text for the pop-up box is passed to the function as a string parameter.

Each section of text in the article is defined as a separate HTML page in a “text” file, having in this embodiment filenames of the form bjvvvpppp_evtextnn.htm. These files contain the HTML tagged text of each text section.

Each figure in the article is defined as a separate HTML page “figure” file, having filenames of the form bjvvvpppp_evfignn.htm. These files contain the title and legend of the figure as HTML tagged text and a <DIV> element used to display the figure in a layer. They also include a tag to load the relevant figures into the HTML frame for display. (As is known in the art, the figures themselves are stored in an appropriate format, such as .jpeg or .gif, and called into the HTML page when they are to be displayed.) As discussed above, in this embodiment, a higher and a lower resolution version of each figure is stored, and called for display as appropriate, depending on the frame size at the time.

The figures are coded like this so that they can be dynamically resized when the frame size is adjusted. The height and width values for the high and low resolution figures are stored as ColdFusion parameters which are used by a figresize( ) function that is held in a separate HTML page for displaying the figures (see below). This page is included in all the figure pages using a ColdFusion <CFINCLUDE> tag so as to avoid unnecessary duplication of the same code in different pages.

Each article for display also includes a file, bjvvvpppp_evfigall.htm, that contains HTML code for displaying all of the figures together on one page. (The figures are not dynamically resizable on this page.)

Each table in the article is defined as a separate HTML page in a “table” file, having filenames of the form bjvvvpppp_evtabnn.htm. These files contain the HTML tagged title, data, caption and any footnotes of the table.

As for the figures, each article for display also includes a file, bjvvvpppp_evtaball.htm, that contains HTML code for displaying all of the tables together on one page.

The text, figures, and tables files and the “all figures” and “all tables” files, also each include a row of buttons along the top that include on MouseOver code to call dropdown menu software and a set of First, Next, Previous and Last buttons to page through each text section, figure or table, as appropriate, in turn.

The text, figure, table, all figures and all tables pages (files) also each include a popupbox.htm file (see below) that contains a JavaScript function that displays a pop-up box showing the text of a reference. This function is triggered by the JavaScript on MouseOver event when a user moves their mouse cursor over a citation link in the text, figure or table. The text for a reference pop-up box is passed to the function as a pointer to an array which is populated by a LoadRefs( ) function. The LoadRefs( ) function creates an array that holds the text for each reference cited on the page (in the file) in question. It is placed at the foot of each file and is triggered by an on Load event handler of the page called in the <BODY> tag.

In this way, each text page, figure page and table page, and the all figures page and the all tables page hold an array in memory of the text for each reference that appears on that page ready to be displayed in a pop-up box.

Each article to be displayed also includes other files for displaying other information relating to the article.

The first such file is a bjvvvpppp_evkwab.htm, containing HTML code to display the keywords, abbreviations used and any other footnotes that do not appear in the other pages. The information in this file appears in the figure frame 4 and is accessed by a menu item in the text frame 3.

Each formatted article also includes a file, bj3810001_evrefs.htm, containing HTML code to display all the references for the article. The links to citations in the text will point to the appropriate point on this page. There are also links to Medline abstracts and CrossRef where available and, uniquely, there are links back to the citations in the text from each reference.

As well as the above files that describe the information in the article that is to be displayed, the following additional files are used to define and describe an article for display.

The first such file is a cascading style sheet file, std_ev.css, that is a cascading style sheet that is included in every other page (using the following HTML code:

<link rel=“stylesheet” href=“/std_ev.css” type=“text/css”>).

This file defines the style of the different text elements of the pages, and also sets the default properties of the <DIV> elements used to create the layers that display the pop-ups and the figures (e.g.:
#refpup {position:absolute; visibility:hidden; z-index:500}
#figdiv {position:relative; visibility:visible; z-index:500}).

Figures are displayed in a <DIV> layer in this way so that they can be dynamically resized when the frame size is changed without having to reload the page (see below).

Each article also includes a file, figholder.htm, that contains the JavaScript code for displaying the figures in a DHTML layer. (The figures are displayed in this manner so that they can be automatically resized when the user changes the size of the frame without having to reload the figure page.)

This file includes a figresize( ) function that is called by on Load( ) and on Resize( ) event handlers in the <BODY> tag of the figure pages. This function uses ColdFusion parameters set in the figure pages to discover the size of the low and high resolution figures. It then works out the size of the frame and whether the frame size is more that 50% of the size of the browser window. If so, it loads the high resolution figure, if not it loads a low resolution figure. The function also works out if the figure is too big to fit in the frame and if so recalculates the height and width of the figure. Once it knows all this, it writes the HTML code into the layer to display the figure. This is in the form of an HTML <IMG> tag that will include the height and width attributes of the image calculated earlier.

The figholder.htm file is included in each page that requires it using the ColdFusion <CFINCLUDE> tag to avoid duplication the same code in every file.

However, as will be appreciated by those skilled in the art, any other suitable technique for including the figholder.htm file in the relevant HTML pages in an analogous manner (i.e. so that it does not need to be included in each HTML page individually) could be used instead. Similarly, although ColdFusion parameters are used in this embodiment to store the variables such as height and width values for the figures, any other suitable way of storing variables in HTML files could be used (both for storing these and any other variables that may need to be stored in the present invention and embodiment).

The next file used for the display is a “popupbox.htm” file that contains the JavaScript code that runs when the on MouseOver event is triggered by a user moving their mouse cursor over a link, e.g. to a reference or author's name (as discussed above). This function starts by initialising the variables that determine how long the pop-up should stay visible after the user's mouse cursor has moved away. It then assigns an object to a variable based on the values in the stylesheet for the pop-up layer. It then works out where the user's mouse cursor is on the page and the size of the frame so that it can determine where on the page to display the pop-up box and how big it should be. If necessary corrections are made to these values if part of the pop-up box would disappear off the edge of the page. The next step is to write the content to the pop-up layer and set the visibility of the layer to true. Finally there is an on MouseOut event attached to the pop-up box and the link that will hide the layer when the mouse cursor is moved away.

The popupbox.htm file is included in each page that requires it using the ColdFusion <CFINCLUDE> tag to avoid duplication the same code in every file (again, any suitable technique could be used for this).

Finally, each article includes a JavaScript file a bj3810001_evtext_menu.js, that defines the JavaScript arrays containing the menu items for the drop down menus for the text, figures, tables, all figures and all tables pages. (The menus themselves can be generated using commercially available software.)

The way that the above files for displaying an article in accordance with the present invention will now be described with reference to FIGS. 6 to 9.

In the present embodiment, the article for display is first described as an XML file using a full text XML schema (document type definition), such as that produced by PubMed Central. The XML file describing the article is then parsed to extract the necessary discrete pieces of information needed to generate the HTML tagging, JavaScript and ColdFusion code for displaying the article.

FIGS. 6 to 10 are flow diagrams showing the steps executed to achieve this parsing of the XML file and to thereby generate the necessary components (files) for displaying an article. A computer program to carry out the steps described in FIGS. 6 to 10 can be written in any suitable language, such as Visual Basic.

FIG. 6 shows the first part of the parsing process, namely reading the relevant data from the XML file 20 describing the article to be displayed.

As shown in FIG. 6, in step S1 the XML file for the article is read and then in step S2 searched for each desired piece of bibliographic information, such as title, volume, pages, etc., which information is then stored in predefined variables.

Steps S3 to S6 then comprise a loop for extracting and storing author information, including the author's name, affiliation and e-mail address. This information is stored in an array as shown in step S4.

The next stage in steps S7 to S10 is to extract the relevant text data. As shown in FIG. 6, each text section is identified and stored in a predefined variable until all the text sections have been so stored.

There is then a corresponding stage of extracting and storing the information relating to the figures in steps S11 to S14. In this case, the title, legend and size of each figure is stored in predefined variables as shown in step S12.

Steps S15 to S18 carry out a similar process in respect of any tables that are described in XML file describing the article. Again, the title, caption and data for any table found is stored in predefined variables as shown in step S16.

Steps S19 to S24 then extract the relevant reference (citation) information. In each case each component part of the reference is extracted from the XML file and a pipe separated file generated and CrossRef and Medline queries built. (As is known in the art, CrossRef and Medline are commercial services that can be used, e.g., for citation information and cross-referencing to cited articles, etc.) Then in step S21 the text of the reference is placed into a JavaScript array file for generating the appropriate pop-up box for storing that information. The reference data is then stored in a predefined array as shown in S22. This is repeated for each reference found in the XML file describing the article.

Once all the relevant data in the XML file describing the article has been read and extracted as described above with reference to FIG. 6, the system then proceeds to generate the relevant files for display of that information.

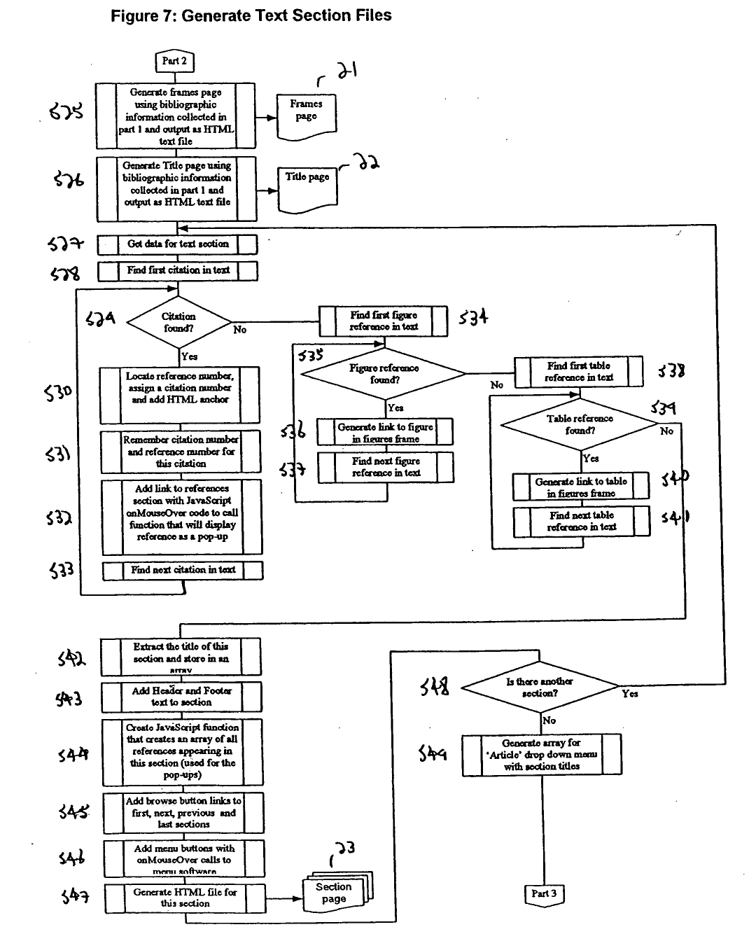

The first stage is to generate the text section files. This is shown in FIG. 7.

The first step S25 is to generate the initial frames page (file) 21 for the display that, as discussed above, inter alia, defines the HTML frames that are used to create the display (and in which the subsequent text section pages, figure pages, etc., will be displayed). This frames page is generated using the bibliographic information collected in step S2 in FIG. 6 and is output as an HTML text file to provide the frames page 21 for the article.

The next step, step S26, is to generate the title HTML page 22 that will be used to display the title information, etc., in the title frame 2. This title page 22 is generated using the bibliographic information collected from the XML file and is output as an HTML text file to provide the title page 22 for the article.

Once the title page 22 has been generated, the system then proceeds to generate text section pages (files) 23 for displaying the text of the article. This process is carried out in steps S27 to S48 shown in FIG. 7.

The first step S27 is to retrieve the data that has previously been extracted for a text section and then to search that text section for a citation (step S28). If a citation is found (step S29), then a reference number for the citation is found, the citation is assigned a citation number and an HTML anchor is added (steps S30 and S31). The citation number is a unique reference number that is assigned to and stored for the citation that will be used for that citation whenever it appears in the text (or figures or tables). This citation number is then used to provide a link from the references section (page) (see below) to the citation, whenever it appears in the text, figures, etc.

A link to the references file to display the relevant reference information when activated is then added (step S32). This link includes JavaScript on MouseOver code which includes a call to the function that will display the reference as a pop-up box, so that the reference information is displayed as a pop-up box when the link is activated.

This process is repeated until all the citations in the relevant text section have been found.

Once all the citations have been referenced and had appropriate links added in the above manner, the system then proceeds to steps S34 to S37 where the text section is searched for figure references, and, where a figure reference is found, adds a link to the figure in the figures frame (step S36). A similar process is then carried out for the tables referenced in the text section (steps S38 to S41), so that appropriate links to the tables in the figures frame can be generated in the text section.

Once all the citation, figure and table references have been found and appropriately identified and had appropriate links provided for them in the text section, the process then proceeds to step S42 where the title of the text section is extracted and stored in an array. Header and footer text are then added to the text section (step S43).

The next step S44 operates to create a JavaScript function that creates an array of all the references appearing in the text section (which will be used for displaying the text references as pop-up boxes, as discussed above).

In steps S45 and S46 browse button links to first, next, previous and last text sections and menu buttons with on MouseOver calls to menu software are added.

Finally, in step S47, an HTML file incorporating all the above elements is generated and stored as the HTML file text section page 23 for display of the text section in question.

The above process is then repeated for all the text sections found in the article (step S48).

Once all the text sections have been formatted as HTML pages 23 as discussed above, then in step S49 an array for an article dropdown menu containing the titles of each text section found for the article is generated.

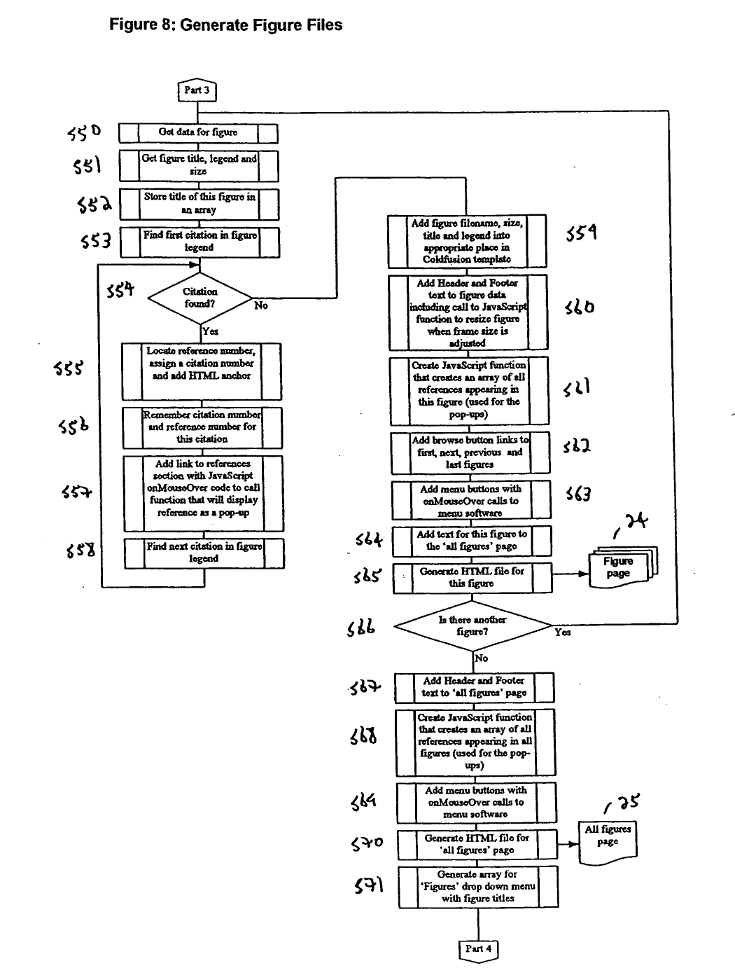

The next stage of the process is then to generate, in a corresponding manner, the HTML pages (files) for each of the figures of the article. This process is shown schematically in FIG. 8.

The first step of this process is to retrieve the extracted data for a figure (step S50) and the figure title, figure legend, and figure size attributes for the low and high resolution versions of the figure (step S51). The title of the figure is then stored in an array (step S52).

The figure legend is then searched for all the citation references, so that those references can be formatted in a similar way as described above for the text section files (steps S53 to S58). Thus, when a citation in the figure legend is identified, the reference number for the citation is located, a citation number is assigned and an HTML anchor is added, together with a link to the references section that includes JavaScript on MouseOver code that includes a call to the function that will display the reference information as a pop-up box.

Once all the citation references have been formatted in the above way, the process proceeds to step S59 in which the figure file name, size attributes, title and legend are placed in a ColdFusion template. Header and footer data are then added to the figure data together with a call to the JavaScript function to resize the figure when the frame size is adjusted (step S60).

A JavaScript function that creates an array of all the references appearing in the figure (to be used for pop-up boxes for displaying those references) is then created (step S61), and browse button links to first, next, previous and last sections and menu buttons with on MouseOver calls to menu software are added (steps S62 and S63).

The code to display the figure, figure title and figure legend for the figure is then added to the “all figures” page (file) (see below) in step S64.

Finally, in step S65, an HTML file for the figure is generated and stored as a figure section page 24 using the above generated and extracted figure components. This is the file that will be used to display the figure on the display and should include, as appropriate, the necessary tags to call the figure into the page for display (to load the appropriate stored figure (e.g. in jpeg or gif format) for display in the figures frame).

This process is repeated for all the figures found in the article (step S66).

Once all the individual figures have been created as HTML section pages (files) 24 in the above manner, the system then proceeds to generate the “all figures” page (file) 25. This process is shown in steps S67 to S70.

Firstly, header and footer text are generated for the “all figures” page (step S67), and then a JavaScript function that creates an array of all the references appearing in all the figures to be used for display as pop-up boxes is created (step S68). Menu buttons with on MouseOver calls to the menu software are then generated in step S69. Finally, the HTML file for the “all figures” page 25 is generated in step S70.

Once the all figures HTML page 25 has been generated, the system then generates an array for the figures dropdown menu with the appropriate titles for each figure and the all figures page to allow a user to directly select a desired figures page for display (step S71).

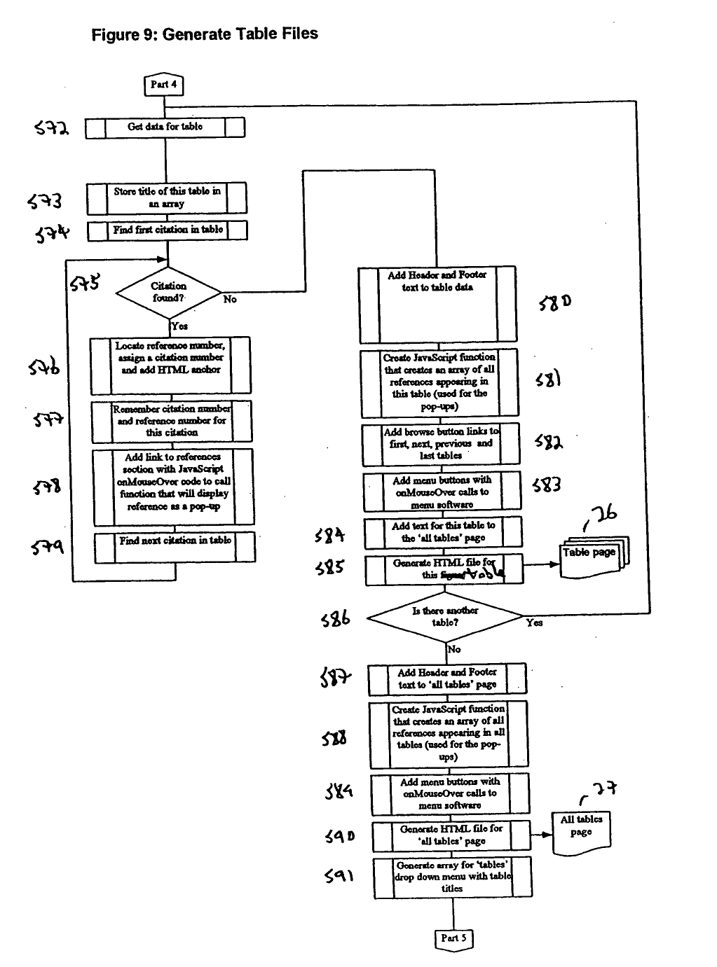

The next stage of the process is then to generate, in a corresponding manner, the HTML pages (files) for each of the tables of the article. This process is shown schematically in FIG. 9.

The first step of this process is to retrieve the extracted data for a table (step S72). The title of the figure is then stored in an array (step S73).

The table data is then searched for all the citation references, so that those references can be formatted in a similar way as described above for the text section and figure files (steps S74 to S79). Thus, when a citation in the table is identified, the reference number for the citation is located, a citation number is assigned and an HTML anchor is added, together with a link to the references section that includes JavaScript on MouseOver code that includes a call to the function that will display the reference as a pop-up box.

Once all the citation references have been formatted in the above way, the process proceeds to step S80 in which header and footer text are added to the table data.

A JavaScript function that creates an array of all the references appearing in the table (to be used for pop-up boxes for displaying those references) is then created (step S81), and browse button links to first, next, previous and last sections and menu buttons with on MouseOver calls to menu software are added (steps S82 and S83).

The code to display the table is then added to the “all tables” page (file) (see below) in step S84.

Finally, in step S85, an HTML file for the table is generated and stored as a table page 26 using the above generated and extracted table components. This is the file that will be used to display the table on the display.

This process is repeated for all the tables found in the article (step S86).

Once all the individual tables have been created as HTML pages (files) 26 in the above manner, the system then proceeds to generate the “all tables” page (file) 27. This process is shown in steps S87 to S90.

Firstly, header and footer text are generated for the “all tables” page (step S87), and then a JavaScript function that creates an array of all the references appearing in all the tables to be used for display as pop-up boxes is created (step S88). Menu buttons with on MouseOver calls to the menu software are then generated in step S89. Finally, the HTML file for the “all tables” page 27 is generated in step S90.

Once the all tables HTML page 27 has been generated, the system then generates an array for the tables dropdown menu with the appropriate titles for each table and the all tables page to allow a user to directly select a desired tables page for display (step S91).

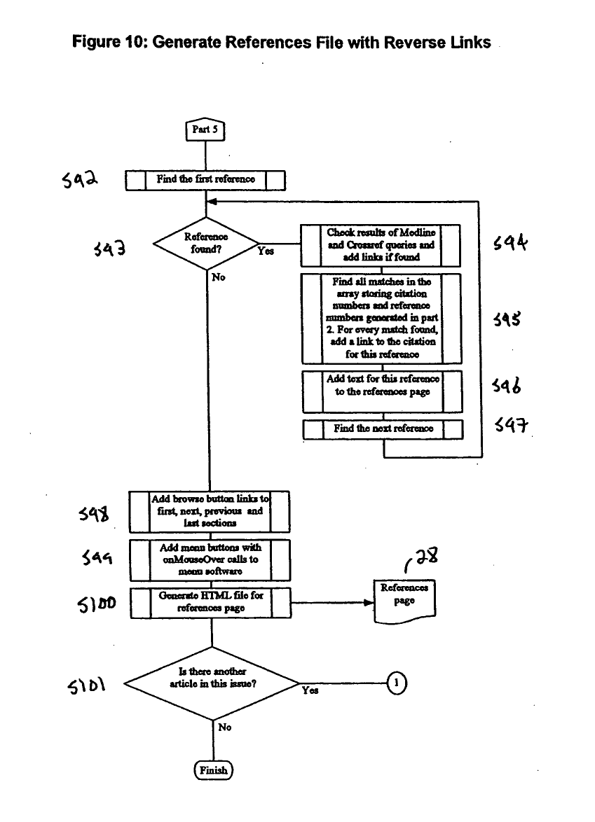

The final stage of the process is to generate the references file in the form of a references HTML page (file) 28. This process is shown schematically in FIG. 10.

The first step of this process is to identify the first reference in the article from the data extracted from the XML file (step S92). When a reference is found (step S93), the results of the Medline and CrossRef queries are checked and if the queries are positive, then appropriate links are added (step S94).

The system then searches for all matches in the array storing the citation numbers and reference numbers that were generated for the text section files, figure files, etc. For every match found, a link is added to the citation for this reference (step S95).

The relevant text for the reference is then added to the references page (step S96). This process is repeated for all references found for the article (step S97).

Then, as for the text, figure and table files, the system proceeds to add browse button links to first, next, previous and last sections of the references file (step S98), and menu buttons with on MouseOver calls to the menu software (step S99). Finally, the appropriate HTML file is generated (step S100) to provide the HTML references page 28 that will be used when displaying the article.

The above process completes the formatting of a single article, which as can be seen, will be described in the form, inter alia, of an HTML frames page 21, an HTML title page 22, HTML pages 23 for each text section, HTML pages 24 for each figure appearing in the article, an “all figures” HTML page 25 that includes all the figures in the article, HTML pages 26 for each table appearing in the article, an “all tables” HTML page 27 that includes all the tables in the article, and a references HTML page 28 that contains reference (citation) information.

The above process is then repeated for any other articles that it is desired to display (step S101), for example that may be present in a scientific journal that it is desired to display in the manner of the present invention.

As will be appreciated by those skilled in the art, articles prepared for display in the above manner will be stored, e.g., on a server, for access by users, e.g. remotely, using, e.g., an Internet browser. In such an arrangement, the system is preferably arranged such that search engines are prevented from indexing individual article components and browsers are prevented from caching individual components of an article, so as to avoid the risk of users being directed to individual pages without having the frames for the display defined first.

As will be appreciated from the above, the present invention, in its preferred embodiments at least, provides an enhanced system for displaying electronically scientific articles (and other documents), that in particular can make reading such articles on screen more user-friendly.

This is achieved in the preferred embodiments of the present invention at least, by allowing related items of information, such as text and the corresponding figure easily to be viewed simultaneously. The available screen area is also used more efficiently by “hiding” information behind pop-ups and using drop-down menus for navigation, such that a reduced amount of scrolling is required to read an article.

1. A method of displaying electronically a scientific article, comprising:
displaying the article using three or more separate frames in a single window on an electronic display, each frame displaying different information relating to the article.

2. The method of claim 1, wherein the window of the display is a browser window of an Internet browser.

3. The method of claim 1, comprising displaying the article using three frames and displaying in one of the frames bibliographic information for the article, displaying in another of the frames text of the article, and displaying in the third frame figures, tables and other non-text items of the article.

4. The method of claim 1, comprising automatically resizing a figure or table that is displayed in a frame as the frame size changes.

5. A method of displaying a scientific article in an electronic form, comprising:
displaying figures of the article in a frame in a window on an electronic display; and
resizing automatically a figure being displayed when the size of the frame that the figure is displayed in is changed.

6. The method of claim 1, comprising:
determining the size of a frame relative to the display window, and automatically displaying a higher resolution image of a figure in the frame when it is determined that the frame's size is equal to or greater than a particular proportion of the display window.

7. A method of displaying electronically a scientific article, comprising:
displaying figures of the article in a frame within a display window; and
automatically displaying a higher resolution image of a figure when the frame for displaying the figure equals or exceeds a selected proportion of the window size.

8. The method of claim 1, comprising including in a frame or frames a link or links to allow a user to change the information displayed and/or to access additional information.

9. A method of displaying electronically a scientific article, comprising:
providing a link or links within the text of the article to bibliographic information for references included in the article; and
displaying the bibliographic information in a pop-up box when the link to such information is activated.

10. A method of displaying electronically a scientific article, comprising:
providing a link or links within the text of the article to author affiliation information for an author or authors of or referred to in the article; and
displaying the author affiliation information in a pop-up box when the link to such information is activated.

11. A method of formatting a scientific article for display in an electronic form, comprising:
storing data describing the article;
generating a file for defining the frameset to be used to display the article; and
generating files for displaying each text section, figure and table to be displayed for the article from the stored information.

12. The method of claim 11, further comprising:
generating a file for displaying all the figures to be displayed for the article from the stored information;
generating a file for displaying all the tables for the article from the stored information; and
generating a file for displaying reference information for the article.

13. A method of formatting a scientific article for display in an electronic form, comprising:
parsing an XML file describing the article to extract information needed to generate HTML tags, and JavaScript and ColdFusion code for describing the article; and
formatting the article as a combination of static HTML pages, ColdFusion templates, and JavaScript scripts, using the information extracted from the XML file.

14. A method of displaying a document electronically, comprising:
displaying the document using three or more separate frames in a single window on an electronic display, each frame displaying different information relating to the document.

15. A system for the electronic display of scientific articles, comprising:
a processor for displaying an article using three or more frames simultaneously in a single window on an electronic display; and
a processor for displaying in each frame different information relating to the article.

16. The system of claim 15, comprising:
a processor for displaying the article using three frames; and
a processor for displaying in one of the frames bibliographic information for the article, displaying in another of the frames text of the article, and displaying in the third frame figures, tables and other non-text items of the article.

17. The system of claim 15, comprising a processor for automatically resizing a figure or table that is displayed in a frame as the frame size changes.

18. A system for displaying a scientific article in an electronic form, comprising:
a processor for displaying figures of the article in a frame in a window on an electronic display; and
a processor for resizing automatically a figure being displayed when the size of the frame that the figure is displayed in is changed.

19. The system of claim 15, comprising:
a processor for determining the size of a frame relative to the display window; and
a processor for automatically displaying a higher resolution image of a figure in the frame when it is determined that the frame's size is equal to or greater than a particular proportion of the display window.

20. A system for displaying electronically a scientific article, comprising:
a processor for displaying figures of the article in a frame within a display window; and
a processor for automatically displaying a higher resolution image of a figure when the frame for displaying the figure equals or exceeds a selected proportion of the window size.

21. The system of claim 15, comprising:
a processor for including in a frame or frames a link or links to allow a user to change the information displayed and/or to access additional information.

22. A system for displaying electronically a scientific article, comprising:
a processor for providing a link or links within the text of the article to bibliographic information for references included in the article; and
a processor for displaying the bibliographic information in a pop-up box when the link to such information is activated.

23. A system for displaying electronically a scientific article, comprising:
a processor for providing a link or links within the text of the article to author affiliation information for an author or authors of or referred to in the article; and
a processor for displaying the author affiliation information in a pop-up box when the link to such information is activated.

24. An apparatus for formatting a scientific article for display in an electronic form, comprising:
a processor for storing data describing the article;
a processor for generating a file for defining the frameset to be used to display the article; and
a processor for generating files for displaying each text section, figure and table to be displayed for the article from the stored information.

25. The apparatus of claim 24, further comprising:
a processor for generating a file for displaying all the figures to be displayed for the article from the stored information;
a processor for generating a file for displaying all the tables for the article from the stored information; and
a processor for generating a file for displaying reference information for the article.

26. An apparatus for formatting a scientific article for display in an electronic form, comprising:
a processor for parsing an XML file describing the article to extract information needed to generate HTML tags, and JavaScript and ColdFusion code for describing the article; and
a processor for formatting the article as a combination of static HTML pages, ColdFusion templates, and JavaScript scripts, using the information extracted from the XML file.

27. A system for the electronic display of documents, comprising:
a processor for displaying a document using three or more frames simultaneously in a single window on an electronic display; and
a processor for displaying in each frame different information relating to the document.

28. A scientific article in electronic format for display, comprising:
a plurality of files, each file for displaying one section of text, or a figure, or a table of the article; and
one or more code files for providing display functions, which code files can be called via the files for displaying the text, figures or tables.

29. An article in an electronic format that has been generated in accordance with the method of claim 11.

30. An article in an electronic format that has been generated in accordance with the method of claim 13.

31. A system for the electronic display of scientific articles, comprising:
means for displaying an article using three or more frames simultaneously in a single window on an electronic display; and
means for displaying in each frame different information relating to the article.

32. An apparatus for formatting a scientific article for display in an electronic form, comprising:
means for storing data describing the article;
means for generating a file for defining the frameset to be used to display the article; and
means for generating files for displaying each text section, figure and table to be displayed for the article from the stored information.

33. An apparatus for formatting a scientific article for display in an electronic form, comprising:
means for parsing an XML file describing the article to extract information needed to generate HTML tags, and JavaScript and ColdFusion code for describing the article; and
means for formatting the article as a combination of static HTML pages, ColdFusion templates, and JavaScript scripts, using the information extracted from the XML file.

34. One or more processor readable storage devices having processor readable code embodied on said processor readable storage devices, said processor readable code for programming one or more processors to perform a method of displaying electronically a scientific article, comprising:
displaying the article using three or more separate frames in a single window on an electronic display, each frame displaying different information relating to the article.

35. One or more processor readable storage devices having processor readable code embodied on said processor readable storage devices, said processor readable code for programming one or more processors to perform a method of displaying a scientific article in an electronic form, comprising:
displaying figures of the article in a frame in a window on an electronic display; and
resizing automatically a figure being displayed when the size of the frame that the figure is displayed in is changed.

36. One or more processor readable storage devices having processor readable code embodied on said processor readable storage devices, said processor readable code for programming one or more processors to perform a method of displaying electronically a scientific article, comprising:
providing a link or links within the text of the article to bibliographic information for references included in the article; and
displaying the bibliographic information in a pop-up box when the link to such information is activated.

37. One or more processor readable storage devices having processor readable code embodied on said processor readable storage devices, said processor readable code for programming one or more processors to perform a method of formatting a scientific article for display in an electronic form, comprising:
storing data describing the article;
generating a file for defining the frameset to be used to display the article; and
generating files for displaying each text section, figure and table to be displayed for the article from the stored information.

38. One or more processor readable storage devices having processor readable code embodied on said processor readable storage devices, said processor readable code for programming one or more processors to perform a method of formatting a scientific article for display in an electronic form, comprising:
parsing an XML file describing the article to extract information needed to generate HTML tags, and JavaScript and ColdFusion code for describing the article; and
formatting the article as a combination of static HTML pages, ColdFusion templates, and JavaScript scripts, using the information extracted from the XML file.
